(19) United States
(12) Patent Application Publication
(10) Pub. No.: US 2006/0212757 A1
(43) Pub. Date: Sep. 21, 2006

(54) Method, system, and program product for managing computer-based interruptions

(75) Inventors: Steven I. Ross, South Hamilton, MA (US); Li-Te Cheng, Malden, MA (US); Uri Dekel, Pittsburgh, PA (US); Susanne C. Hupfer, Lexington, MA (US); John F. Patterson, Carlisle, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/080,151

(22) Filed: Mar. 15, 2005

(51) Int. Cl. G06F 11/00

(52) U.S. Cl. 714/34

(57) ABSTRACT

The present invention provides a method, system, and computer program product for managing computer-based interruptions. The method comprises receiving an interruption directed at a user, and selectively suppressing delivery to the user of an interruption notification corresponding to the interruption, based on a current state of the user, a classification of the interruption, and a set of interruption management policies.

### BACKGROUND OF THE INVENTION

1. Field of the Invention

The present invention generally relates to computer systems. More particularly, the present invention provides a method, system, and computer program product for managing computer-based interruptions.

2. Related Art

In the “real world” of face-to-face encounters, individuals use a variety of criteria to decide when to interrupt one another. A person may wander over to a co-worker's office, for example, and peek in before interrupting. He or she may find the office door open or closed, and may see that the co-worker is on the phone or in a meeting with other colleagues, hunched over the computer typing, reading a book, or staring absently into space. Depending on what is found, the urgency of the issue, and the nature of their relationship, the visitor may decide to interrupt, to walk away and try again later, to pursue contact through some other means, or to give up entirely and seek help elsewhere. The co-worker may even have some peripheral awareness of the attempt at contact, and may hastily negotiate future contact, such as when a person on the phone gestures that they will be available in a moment.

In the world of technology-based communication, however, from the telephone to instant messaging, interruptions are typically automatic and immediate. The person seeking communication has no feedback about what activities another person is engaged in, and the other person is immediately interrupted by a ringing phone, an incoming email notification, an instant message popping up in front of their work, etc. The technology provides a few coarse remedies, such as the ability to leave the phone off the hook or put the instant messaging system into a do-not-disturb state, but these go to the other extreme of blocking all attempts at communication.

The introduction of collaboration technologies into a business environment often results in users fielding frequent interruptions and feeling an increasing sense of loss of control over their environment. While providing instant access to anyone may be ideal for the person initiating contact, it is frequently non-optimal for the person being contacted. To optimize organizational productivity, therefore, a balance must be struck. Accordingly, there is a need for an interruption management mechanism for use with collaboration tools that is capable of providing improved concentration, higher productivity, and increased job satisfaction for users.

### SUMMARY OF THE INVENTION

In general, the present invention provides a method, system, and computer program product for managing computer-based interruptions.

The present invention provides a unified interruption manager that can be integrated with many different types of collaboration tools. The interruption manager serves as a central clearinghouse for all computer programs that wish to interrupt a user. Each interruption request is evaluated based on the current user context and on a set of policies specified by the user. These policies specify how to handle specific kinds of interruptions under specific circumstances.

Each person is unique and has varying tolerance and receptivity to interruptions under different circumstances. By allowing a user to determine under what conditions and in what manner they will be interrupted, the present invention helps the user to regain some measure of control over their environment, improving their productivity and effectiveness as a result.

A first aspect of the present invention is directed to a method for managing computer-based interruptions, comprising: receiving an interruption directed at a user; and selectively suppressing delivery to the user of an interruption notification corresponding to the interruption, based on a current state of the user, a classification of the interruption, and a set of interruption management policies.

A second aspect of the present invention is directed to a system for managing computer-based interruptions, comprising: a system for receiving an interruption directed at a user; and a system for selectively suppressing delivery to the user of an interruption notification corresponding to the interruption, based on a current state of the user, a classification of the interruption, and a set of interruption management policies.

A third aspect of the present invention is directed to a program product stored on a computer readable medium for managing computer-based interruptions, the computer readable medium comprising program code for performing the following steps: receiving an interruption directed at a user; and selectively suppressing delivery to the user of an interruption notification corresponding to the interruption, based on a current state of the user, a classification of the interruption, and a set of interruption management policies.

A fourth aspect of the present invention provides a system for managing computer-based interruptions, comprising: a computer infrastructure being operable to: receive an interruption directed at a user; and selectively suppress delivery to the user of an interruption notification corresponding to the interruption, based on a current state of the user, a classification of the interruption, and a set of interruption management policies.

A fifth aspect of the present invention provides computer software embodied in a propagated signal for managing computer-based interruptions, the computer software comprising instructions to cause a computer system to perform the following functions: receive an interruption directed at a user; and selectively suppress delivery to the user of an interruption notification corresponding to the interruption, based on a current state of the user, a classification of the interruption, and a set of interruption management policies.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an interruption management system including an interruption manager in accordance with an embodiment of the present invention.

FIG. 2 depicts the interruption manager of FIG. 1 in greater detail.

FIGS. 3-7 and 9 depict a preference definition dialog in accordance with an embodiment of the present invention.

FIG. 8 depicts a dialog for indicating a desired action to be taken in accordance with an embodiment of the present invention.

FIG. 10 depicts an interruption notification in accordance with the present invention.

FIG. 11 depicts a preference definition dialog for editing a system generated interruption management policy in accordance with an embodiment of the present invention.

FIG. 12 depicts a list of suppressed interruption notifications in accordance with an embodiment of the present invention.

FIG. 13 depicts an illustrative system for implementing the interruption management system of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for managing computer-based interruptions.

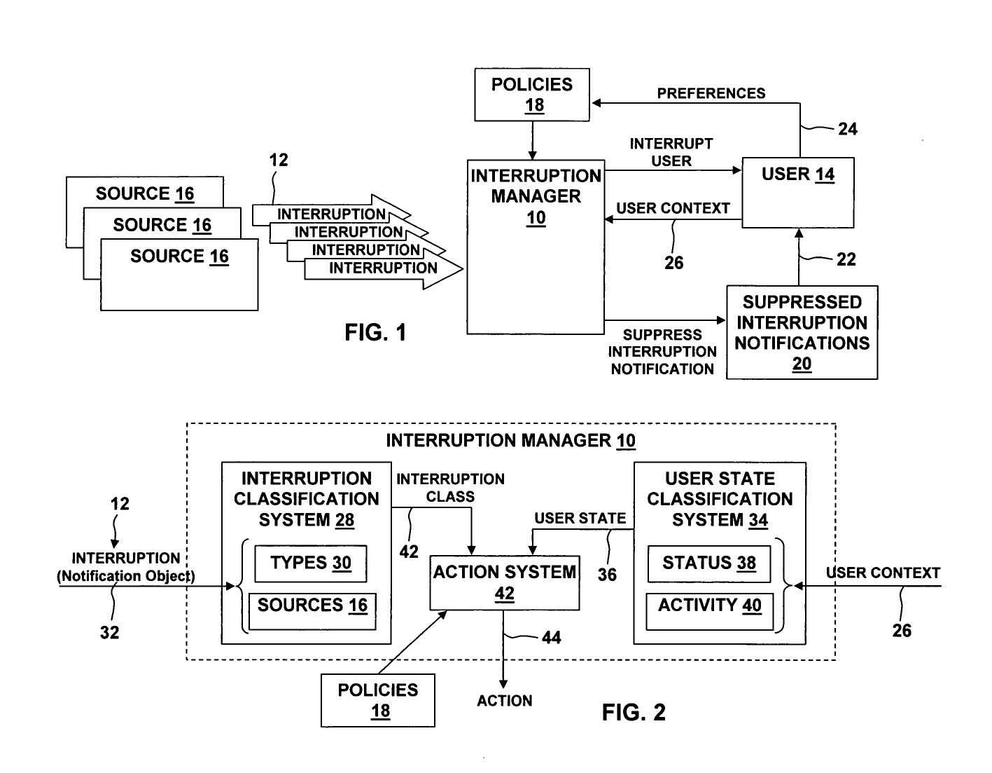

As shown in FIG. 1, the present invention provides an interruption manager 10 that serves as a “pinch point” for all interruptions 12 directed at a user 14 from one or more sources 16 (e.g., computer programs, collaboration tools, etc.). A set of interruption management policies 18 are used by the interruption manager 10 to determine the disposition of each received interruption 12 (e.g., interrupt user, notify user of interruption, suppress interruption notification, etc.). Suppressed interruption notifications 20 are stored and can later be accessed 22 at the convenience of the user 14. The user 14 can specify interruption policy preferences 24 for determining how different types of interruptions 12 will be handled by the interruption manager 10 under different user contexts 26.

As shown in FIG. 2, the interruption manager 10 includes an interruption classification system 28 that classifies each interruption 12 by its interruption type 30 and source 16. The interruption type 30 represent the form of the interruption 12, such as chat, message, screen share, phone call, alert, etc. Other interruption types 30 are also possible. The source 16 of an interruption 12 can be a person or an automated source/program such as a calendar, alert system, system service, etc. Information regarding an interruption 12 can be passed to the interruption manager 10 via a notification object 32 or other suitable mechanism.

The interruption manager 10 also includes a user state classification system 34 for classifying the state 36 of the user 14 based on the current status 38 of the user 14 (e.g., available, busy, do-not-disturb, etc.) and current activity 40 being performed by the user 14 (e.g., debugging, editing, typing, idle, etc.). Interruption management policies 18 are used by an action system 42 to associate particular actions 44 with different interruption classes 42 under specific user states 36. Available actions 44 could include a standard interruption notification (e.g., an interruption notification dialog), or suppression of an interruption notification along with a choice of indicators that the interruption notification was suppressed, including no indication whatsoever, and several alternative forms of auditory and visual signals.

The interruption manager 10 is a general-purpose mechanism that relies on the interruption sources 16 to provide specific behavior appropriate to the source 16. Each interruption type 30 and source 16 registers with the interruption manager 10, specifying what kinds of interruptions 12 the interruption manager 10 will encounter and where these interruptions 12 may originate from. In addition, sources of user context 26 information also register with the interruption manager 10, providing it with labels for the various kinds of state information that can influence the processing of interruptions 12, and also with the means to ascertain that state information. Finally, the actions 44 that the interruption manager 10 can take are also registered.

When an interruption 12 occurs, a notification object 32 is created and passed to the interruption manager 10. The notification object 32, which is sub-classed for each interruption type 30, provides the interruption manager 10 with all the information it needs to evaluate the interruption 12, and decide on its disposition. A visual representation of the notification object 32 can be provided and displayed to the user 14, who can then act on the notification, when appropriate.

Suppressed interruption notifications 20 are collected and made available to the user 14 upon request. Each suppressed interruption notification 20 provides direct access to the interruption 12 communication itself, and also to the user state 36 and interruption management policy 18 information that caused the interruption 12 to be suppressed or allowed.

The interruption manager 10 decides on the disposition of a notification object 32 associated with an interruption 12 by matching characteristics of the notification object 32 and information about the current user context 26 against the user's set of interruption management policies 18. The interruption manager 10 decides whether to notify the user 14 immediately or whether to suppress and store the interruption notification 20 for later access by the user 14. In the latter case, the interruption manager 10 chooses whether and how to notify the user 14 that there are suppressed interruption notifications 20 pending based on the associated interruption management policy 18 settings.

The user 14 can call up the list of suppressed interruption notifications 20 at any time. Each suppressed interruption notification 20 can be viewed and acted upon by the user 14, just as it would have been if it had not been suppressed. The user 14 can read and respond to an asynchronous message, for example. In the case of a synchronous notification like an Instant Messaging Chat or phone call, the user 14 can attempt to reestablish contact with the source of the interruption, assuming that the interruption type provides a method to do so. The user 14 can leave the suppressed interruption notification 20 in the list as a reminder, or can delete it if it is no longer needed. The user 14 can also choose to defer an interruption notification 20 that is displayed immediately, moving it off the screen and into the list of suppressed interruption notifications 20.

Regardless of whether an interruption notification is displayed immediately or suppressed, the user 14 can determine which interruption management policies 18 and/or interruption policy preferences 24 resulted in the particular disposition of the interruption notification 20. The user 14 will then be able to edit or delete existing interruption management policies 18, or to add one or more new interruption management policies 18. This utility allows the user 14 to fine-tune their interruption management policies 24 as they see the effects of their specifications in action. One particularly useful and easy way of modifying interruption management policies 18 includes giving the interruption manager 10 feedback on interruption notifications that were permitted, indicating that they should have been deferred, or on interruption notifications 20 that were deferred, indicating that they should have been permitted. This feedback can result in modifications to the existing interruption management policies 18 to more closely conform to the wishes of the user 14.

How the initiator of an interruption 12 perceives the actions of the interruption manager 10 depends upon the interruption type 30. In the case of asynchronous messages, for example, there is no expectation of immediate response, so there is no need for an indication that a message notification has been suppressed. Initiators of synchronous communication attempts, however, will generally require feedback that they have been unsuccessful, and why. For voice communication, an answering machine or voice-mail type response might be appropriate. A similar mechanism could also be used for instant messaging communication, where a chat response is generated indicating that the user 14 is currently unavailable and perhaps allow the initiator to leave an asynchronous message instead.

It should be noted that although of our discussion here has been focused on interruptions stemming from communication or collaboration software, the mechanism described herein is general purpose, and can be used to manage any kind of computer-based interruption from any source, including sensor based systems, internet news or weather monitors, etc. Further, although envisioned for use in a desktop environment, the same sort of mechanism could prove useful in a handheld PDA, or even a cell-phone environment.

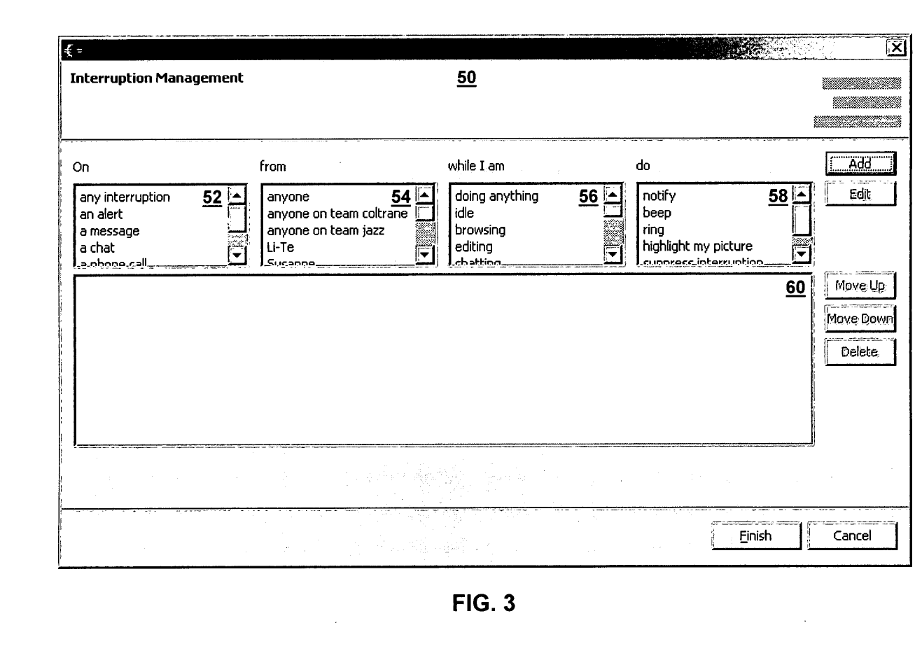

The user 14 can define their interruption management policies 18 in several different ways. For example, the interruption policy preferences 24 of an interruption management policy 18 can be defined and edited by the user 14 using the illustrative preference definition dialog 50 depicted in FIG. 3. Another option is to incrementally set or modify their interruption policy preferences 24 by indicating that a suppressed interruption notification 20 should have been permitted, or that a received interruption notification should have been suppressed.

The illustrative preference definition dialog 50 depicted in FIG. 3 allows the user 14 to define under what conditions and in what manner he or she will be interrupted. The preference definition dialog 50 includes a set of selection panes 52, 54, 56 for defining interruption conditions, a selection pane 58 for defining an action 44 to be taken in response to the defined interruption conditions, and a pane 60 for listing the interruption management policies 18 defined by the user 14. The “On” selection pane 52 is used to define the type 30 of interruption 12 (e.g., “any interruption,” “an alert,” “a message,” “a chat,” “a phone call,” etc.). The “from” selection pane 54 is used to define the source 16 of the interruption 12 (e.g., “anyone,” “anyone on team coltrane,” “anyone on team jazz,” “Li-Te,” “Susanne,” etc.). The “while I am” selection pane 56 is used to define user 14 status/activity (e.g., “doing anything,” “idle,” “browsing,” “editing,” “chatting,” etc.). The “do” selection pane 58 defines the action that will be taken when the selected interruption conditions have been met (e.g., “notify,” “beep,” “ring,” “highlight my picture,” “suppress interruption,” etc.). It will be apparent to those skilled in the art that many different user interface (UI) techniques can be used to define the interruption conditions and corresponding action to take in response thereto in accordance with the present invention. Accordingly, the illustrative preference definition dialog 50 is not intended to be limiting in any way.

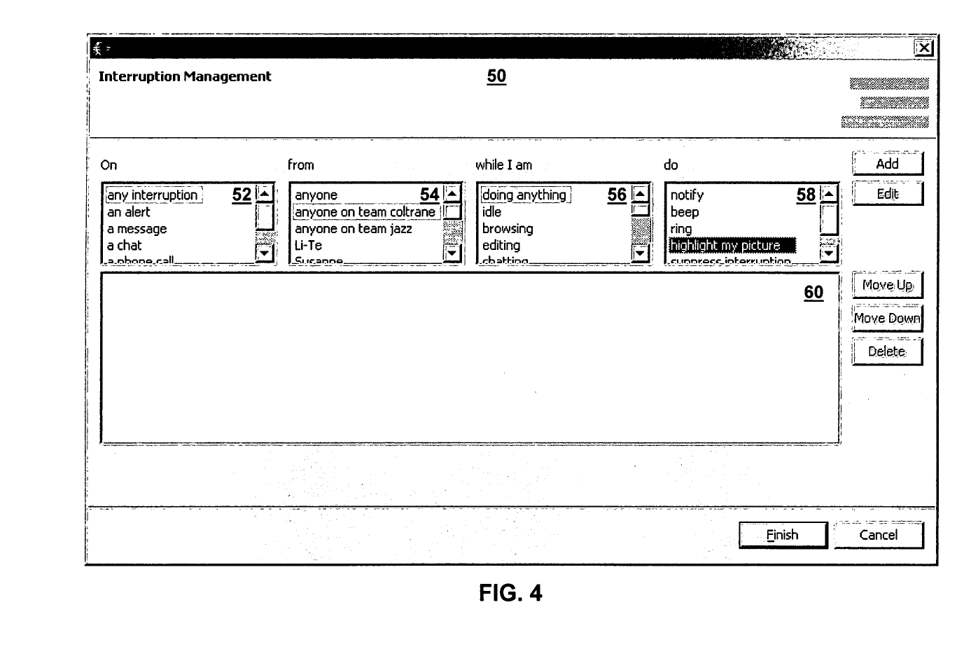

As shown in FIG. 4, the user 14 has selected the following interruption policy preferences 24 in the preference definition dialog 50:

On: “any interruption”;

From: “anyone on team coltrane”;

While I am: “doing anything”;

Do: “highlight my picture.”

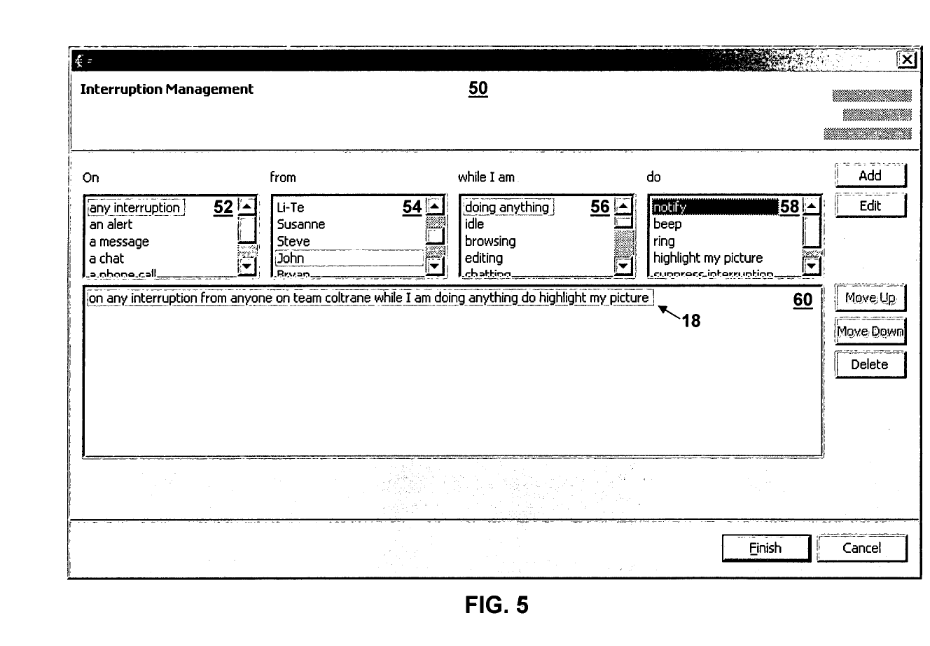

Thus, any interruptions from members of team “coltrane” will cause the picture of user 14 to be highlighted. The resulting interruption management policy 18 is listed in pane 60 of the preference definition dialog 50 (FIG. 5).

As shown in FIG. 5, the user 14 has also defined interruption conditions specifying immediate notification in response to interruptions from a specific person (e.g., “John”). In particular, the user 14 has selected the following in the preference definition dialog 50:

On: “any interruption”;

From: “John”;

While I am: “doing anything”;

Do: “notify.”

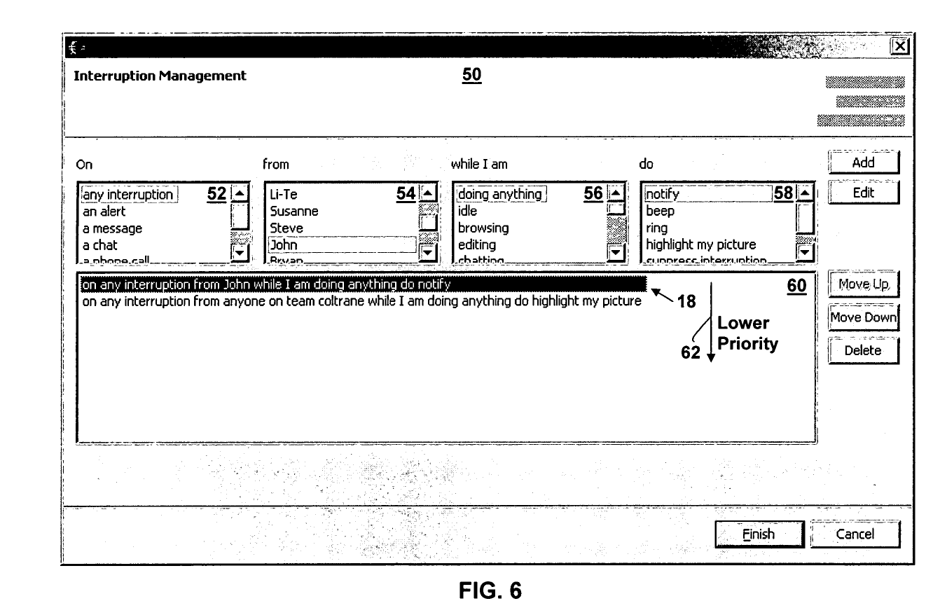

As shown in FIG. 6, this interruption management policy 18 has also been listed in pane 60 of the preference definition dialog 50. Since the conditions of this interruption management policy 18 are more specific than the previously entered interruption management policy 18, this interruption management policy 18 is given a higher priority by the interruption manager 10. In this example, the interruption management policies 18 are arranged in order of priority from highest to lowest as indicated by arrow 62.

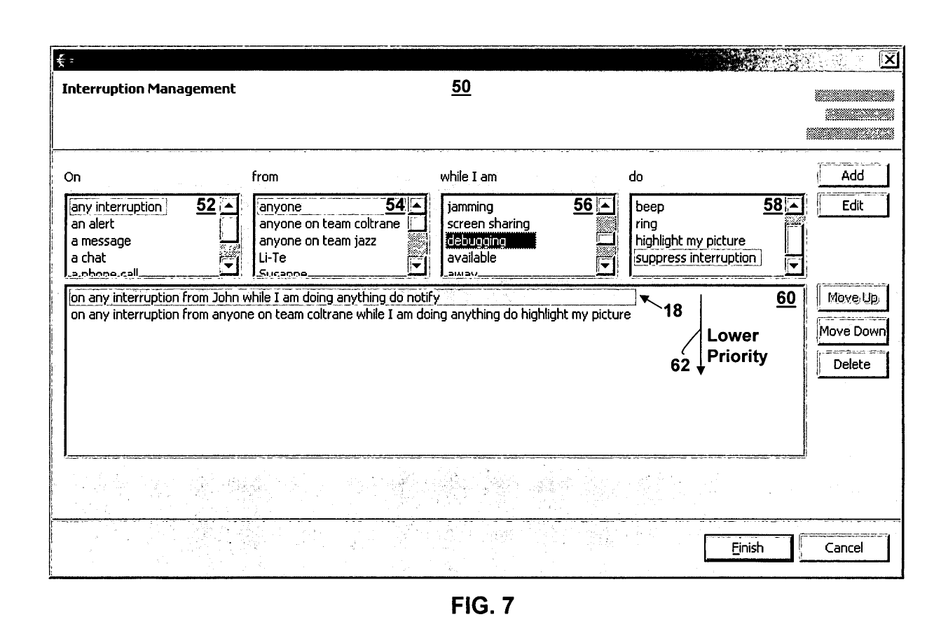

The user 14 next defines another interruption management policy 18, as depicted in FIG. 7, which is designed to minimize disturbances while the user 14 is debugging. In particular, the user 14 has selected the following interruption policy preferences 24 in the preference definition dialog 50:

On: “any interruption”;

From: “anyone”;

While I am: “debugging”;

Do: “suppress interruption.”

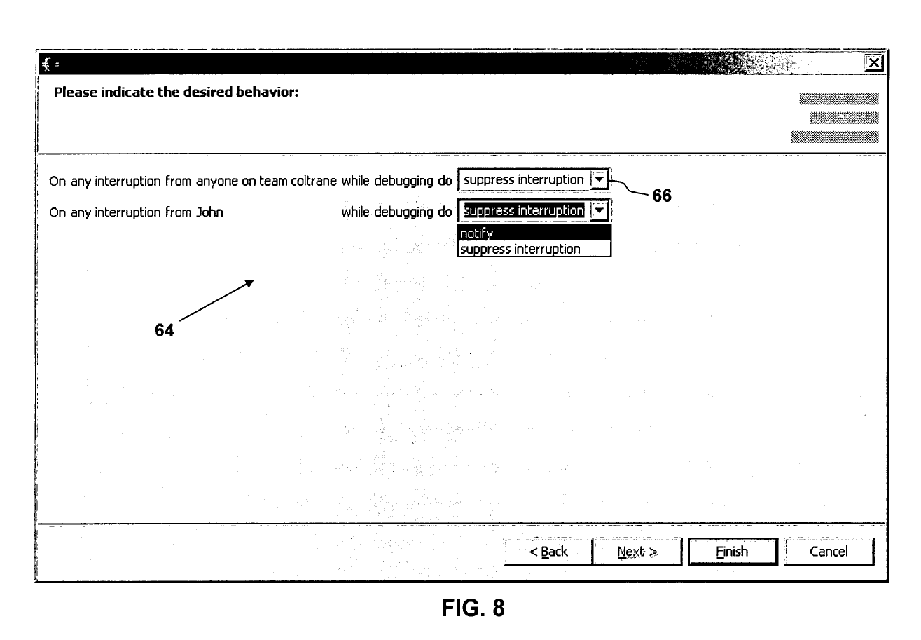

In this case, the priority of the resulting interruption management policy 18 cannot be determined by the interruption manager 10. As such, the interruption manager 10 asks the user 14 one or more questions 64 (FIG. 8) in order to clarify the intent of the user 14. As shown in FIG. 8, for example, the interruption manager 10 asks the user 14 to indicate (e.g., via a drop-down window 66) which action should be taken (e.g., “suppress interruption,” “notify”) in response to the following scenarios:

(A) “On any interruption from anyone on team coltrane while debugging do”; and

(B) “On any interruption from John while debugging do.”

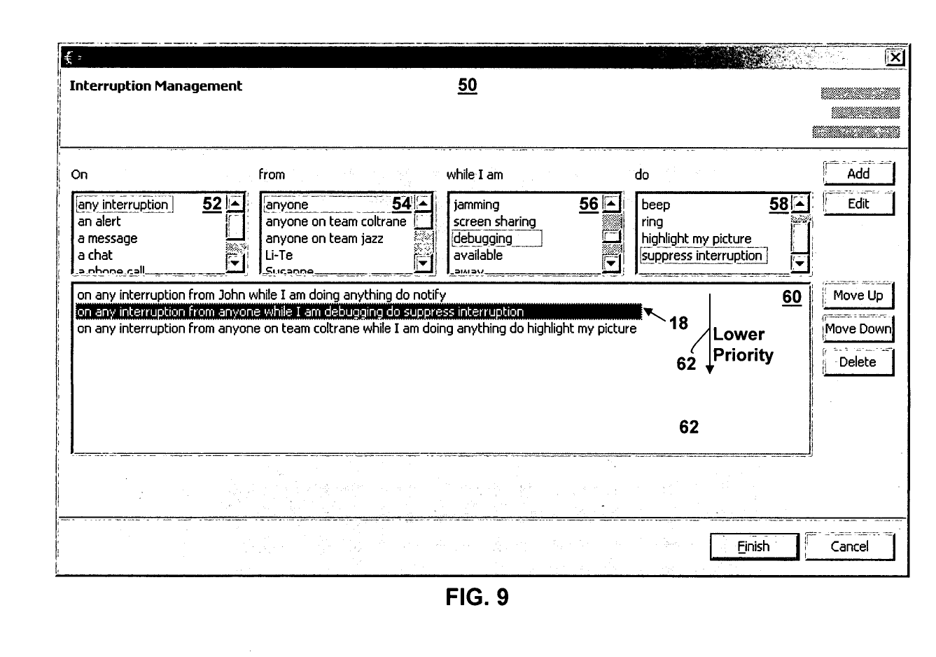

In response to the answers of the user 14, the interruption manager 10 determines the priority of the new interruption management policy 18 relative to the existing interruption management policies 18. This is illustrated in FIG. 9.

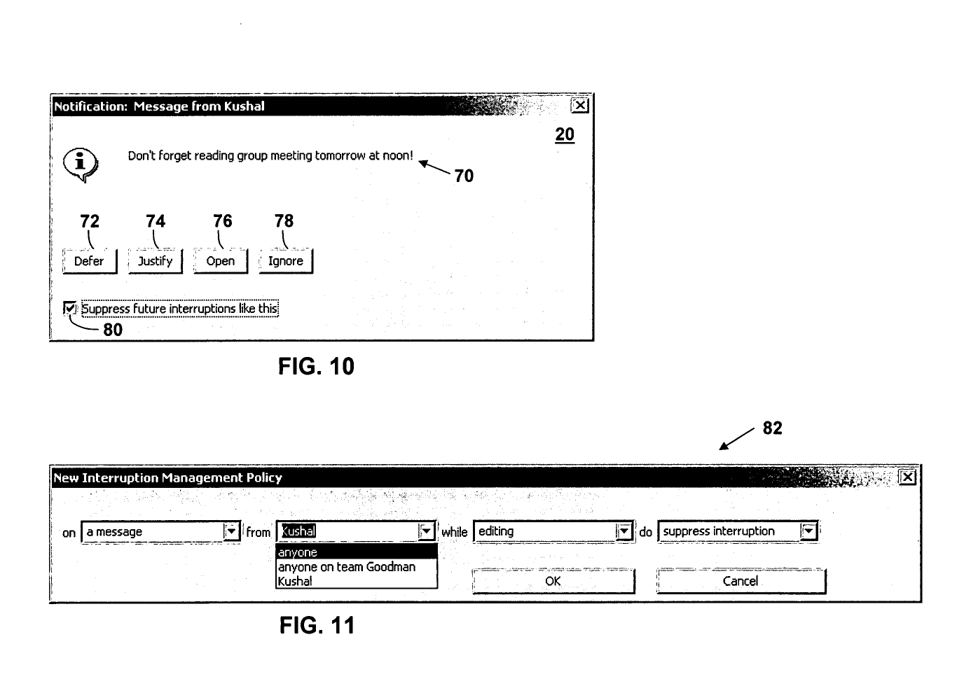

An example of an interruption notification 20 is illustrated in FIG. 10. The interruption notification 20 provides a description 70 of the corresponding interruption 12 and a plurality of action buttons including, for example, a “Defer” button 72, a “Justify” button 74, an “Open” button 76, and an “Ignore” button 78. When the “Defer” button 70 is selected by the user 14 in response to the receipt of the interruption notification 20, the interruption notification 20 is suppressed for later access by the user 14. If the “Suppress future interruptions like this” selection box 80 is selected by the user 14, all similar future interruption notifications 20 will also be suppressed. The resulting system generated interruption management policy 18 can be edited by the user 14 via a preference definition dialog 82 such as that illustrated in FIG. 11.

The user 14 can open the interruption notification 20 by selecting the “Open” button 76 and can ignore the interruption notification 20 by selecting the “Ignore” button 78. The user 14 can select the “Justify” button 74 to determine why the interruption notification 20 was received. For example, the interruption notification 20 may have been received because none of the existing interruption management policies 18 apply to this particular interruption notification 20.

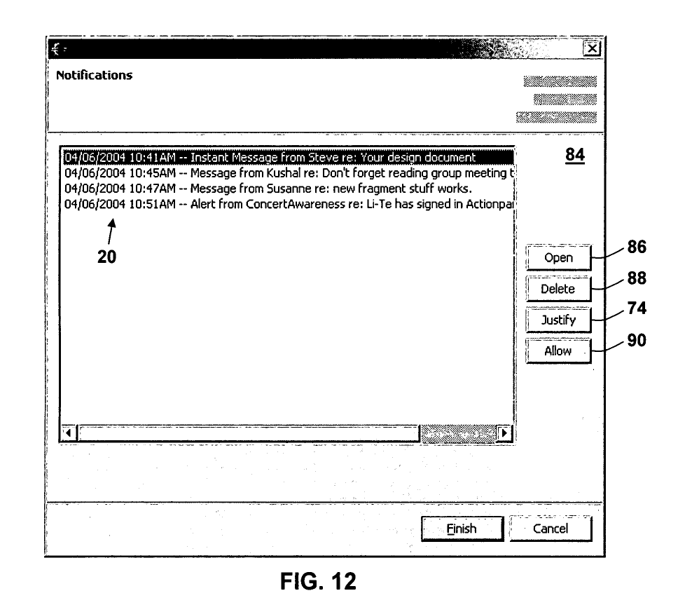

The user 14 can view the suppressed interruption notifications 20 at any time, at their own convenience. An illustrative notification dialog 84 listing the suppressed interruption notifications 20 is shown in FIG. 12. The user 14 can open or delete a selected interruption notification 20 by selecting the “Open” button 86 or “Delete” button 88, respectively. The user 14 can select the “Justify” button 90 to determine why the interruption notification 20 was suppressed. Finally, the user 14 can decide to allow the interruption notification 20 in the future by selecting the “Allow” button 92.

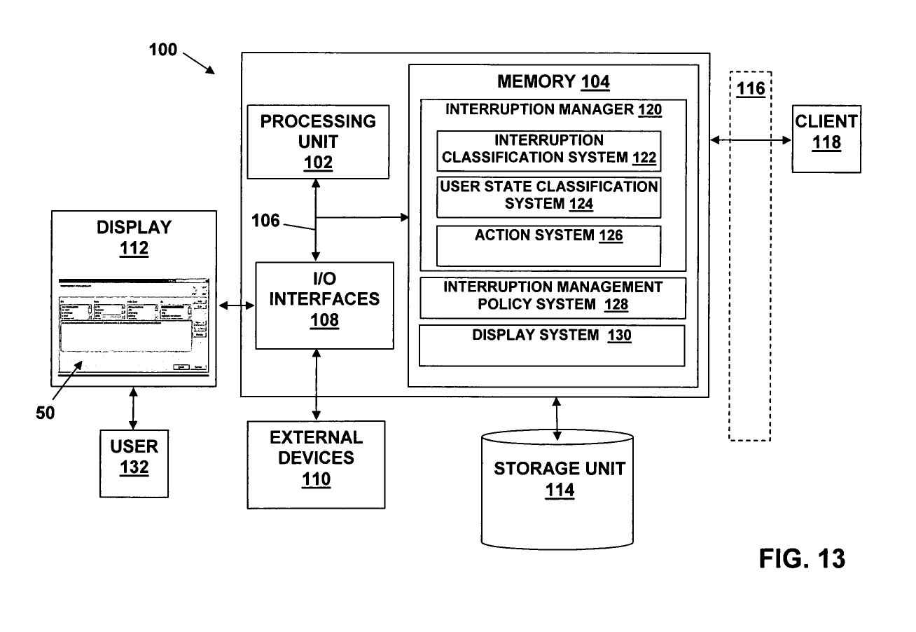

A computer system 100 for managing computer-based interruptions in accordance with an embodiment of the present invention is depicted in FIG. 13. Computer system 100 generally includes a processing unit 102, memory 104, bus 106, input/output (I/O) interface(s) 108, and external devices/resource(s) 110. Processing unit 102 may comprise a single processing unit, or may be distributed across one or more processing units in one or more locations. Memory 104 may comprise any known type of data storage and/or transmission media, including magnetic media, optical media, random access memory (RAM), read-only memory (ROM), etc. Moreover, similar to processing unit 102, memory 104 may reside at a single physical location, comprising one or more types of data storage, or be distributed across a plurality of physical systems in various forms.

I/O interface(s) 108 may comprise any system for exchanging information to/from an external source. External devices/resource(s) 110 may comprise any known type of external device, including speakers, a CRT, LCD screen, handheld device, keyboard, mouse, voice recognition system, speech output system, printer, monitor/display (e.g., display 112), facsimile, pager, etc.

Bus 106 provides a communication link between each of the components in computer system 100, and likewise may comprise any known type of transmission link, including electrical, optical, wireless, etc. In addition, although not shown, additional components, such as cache memory, communication systems, system software, etc., may be incorporated into computer system 100.

Data (e.g., interruption management policies 18, interruption policy preferences 24, suppressed interruption notifications 20, etc.) used in the practice of the present invention can be stored locally to computer system 100, for example, in storage unit/database 114, and/or may be provided to computer system 100 over a network 116. Storage unit/database 114 can be any system capable of providing storage for data and information under the present invention. As such, storage unit/database 114 may reside at a single physical location, comprising one or more types of data storage, or may be distributed across a plurality of physical systems in various forms. In another embodiment, storage unit/database 114 may be distributed across, for example, a local area network (LAN), wide area network (WAN) or a storage area network (SAN) (not shown).

Network 116 is intended to represent any type of network over which data can be transmitted. For example, network 116 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server. One or more client devices 118 may be connected to computer system 100 via network 116. Each client device 118 comprises components similar to those described above with regard to computer system 100.

Shown in memory 104 as a computer program product is an interruption manager 120 for managing computer-based interruptions in accordance with the present invention. Interruption manager 120 includes an interruption classification system 122 for classifying interruptions directed at a user, a user state classification system 124 for classifying a user state, and an action system 126 for associating particular actions with different interruption classes under specific user states, based on defined interruption management policies 18. Also shown in memory 104 is an interruption management policy system 128 for defining, editing, deleting, etc., the interruption management policies 18 used by the interruption manager 120. A display system 130 is provided for displaying the various dialogs (e.g., preference definition dialog 50) to a user 132 on display 112.

It should be appreciated that the teachings of the present invention can be offered as a business method on a subscription or fee basis. For example, one or more components of the present invention could be created, maintained, supported, and/or deployed by a service provider that offers the functions described herein for customers. That is, a service provider could be used to manage computer-based interruptions, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for managing computer-based interruptions, comprising:
receiving an interruption directed at a user; and
selectively suppressing delivery to the user of an interruption notification corresponding to the interruption, based on a current state of the user, a classification of the interruption, and a set of interruption management policies.

2. The method of claim 1, wherein the step of selectively suppressing delivery further comprises:
adding the suppressed interruption notification to a list of suppressed interruption notifications.

3. The method of claim 2, further comprising:
accessing a suppressed interruption notification from the list of suppressed interruption notifications; and
retrieving information regarding the interruption corresponding to the accessed interruption notification.

4. The method of claim 2, further comprising:
accessing a suppressed interruption notification from the list of suppressed interruption notifications; and
retrieving information regarding a cause of the suppressed delivery of the accessed interruption notification.

5. The method of claim 1, further comprising:
informing the user that delivery of the interruption notification has been suppressed.

6. The method of claim 1, further comprising:
determining the current state of the user by:
determining a status of the user; and
determining an activity being performed by the user.

7. The method of claim 1, further comprising:
determining the classification of the interruption by:
determining a type of the interruption; and
determining a source of the interruption.

8. The method of claim 1, further comprising:
defining the set of interruption management policies.

9. The method of claim 8, wherein the set of interruption management policies are defined by the user.

10. The method of claim 8, further comprising:
editing the set of interruption policies.

11. The method of claim 1, further comprising:
receiving an interruption notification; and
selectively adding the received interruption notification to a list of suppressed interruption notifications.

12. The method of claim 1, further comprising:
receiving an interruption notification;
determining why the interruption notification was received; and
editing the set of interruption management policies to suppress a future delivery of the received interruption notification.

13. Deploying an application for managing computer-based interruptions, comprising:
providing a computer infrastructure being operable to perform the method of claim 1.

14. Computer software embodied in a propagated signal for managing computer-based interruptions, the computer software comprising instructions to cause a computer system to perform the method of claim 1.

15. A system for managing computer-based interruptions, comprising:
an interruption receiving system for receiving an interruption directed at a user; and
a system for selectively suppressing delivery to the user of an interruption notification corresponding to the interruption, based on a current state of the user, a classification of the interruption, and a set of interruption management policies.

16. The system of claim 15, wherein the system for selectively suppressing delivery further comprises:
a system for adding the suppressed interruption notification to a list of suppressed interruption notifications.

17. The system of claim 16, further comprising:
a system for accessing a suppressed interruption notification from the list of suppressed interruption notifications; and
a system for retrieving information regarding the interruption corresponding to the accessed interruption notification.

18. The system of claim 16, further comprising:
a system for accessing a suppressed interruption notification from the list of suppressed interruption notifications; and
a system for retrieving information regarding a cause of the suppressed delivery of the accessed interruption notification.

19. The system of claim 15, further comprising:
a system for informing the user that delivery of the interruption notification has been suppressed.

20. The system of claim 15, further comprising:
a system for determining the current state of the user by:
determining a status of the user; and
determining an activity being performed by the user.

21. The system of claim 15, further comprising:
a system for determining the classification of the interruption by:
determining a type of the interruption; and
determining a source of the interruption.

22. The system of claim 15, further comprising:
a system for defining the set of interruption management policies.

23. The system of claim 22, wherein the set of interruption management policies are defined by the user.

24. The system of claim 22, further comprising:
a system for editing the set of interruption policies.

25. The system of claim 15, further comprising:
a system for receiving an interruption notification; and
a system for selectively adding the received interruption notification to a list of suppressed interruption notifications.

26. The system of claim 15, further comprising:
a system for receiving an interruption notification;
a system for determining why the interruption notification was received; and
a system for editing the set of interruption management policies to suppress a future delivery of the received interruption notification.

27. A program product stored on a computer readable medium for managing computer-based interruptions, the computer readable medium comprising program code for performing the following steps:
receiving an interruption directed at a user; and
selectively suppressing delivery to the user of an interruption notification corresponding to the interruption, based on a current state of the user, a classification of the interruption, and a set of interruption management policies.
